(19) United States
(12) Patent Application Publication
(10) Pub. No.: US 2015/0077215 A1
(43) Pub. Date: Mar. 19, 2015

(54) Device and Method to Additively Fabricate Structures Containing Embedded Electronics or Sensors

(71) Applicant: Northeastern University, Boston, MA (US)

(72) Inventors: Richard Ranky, Ridgewood, NJ (US); Alexandra Carver, Arlington, MA (US); Constantinos Mavroidis, Arlington, MA (US); Daniel Landers, Cambridge, MA (US); Mark L. Sivak, Boston, MA (US)

(21) Appl. No.: 14/396,170

(22) PCT Filed: Apr. 26, 2013
(86) PCT No.: PCT/US13/38470

§ 371 Date: Oct. 22, 2014

Related U.S. Application Data
(60) Provisional application No. 61/638,576, filed on Apr. 26, 2012.
(60) Provisional application No. 61/804,440, filed on Mar. 22, 2013.

(51) Int. Cl. B29C 67/00; H01C 10/10

(52) U.S. Cl. CPC B29C 67/0055; B29C 67/0088; H01C 10/10; B29K 2083/00
USPC 338/47; 264/104; 264/105; 425/375

(57) ABSTRACT

A method of constructing an object includes depositing a first material in a predetermined arrangement to form a structure. The method further includes depositing a second material within the structure. The second material may have electrical properties and the method also includes providing electrical access to the second material to enable observation of the one or more electrical properties.

### CROSS REFERENCE TO RELATED APPLICATIONS

This application claims benefit of the following Patent Applications, the contents of which are hereby incorporated by reference in their entirety: U.S. Provisional Patent Application Ser. No. 61/638,576, filed Apr. 26, 2012 and U.S. Provisional Patent Application Ser. No. 61/804,440, filed Mar. 22, 2013.

### BACKGROUND

1. Field of Invention

This invention generally relates to methods and systems of Additive Manufacturing. More particularly, the invention relates to a motorized hardware extruder that can inject or extrude a conductive material (for example, a piezoresistive elastomer) into parts as they are being fabricated by a 3D printer or other Additive Manufacturing system.

2. Description of Related Art

An object with complex freeform three-dimensional (3D) contours can be very challenging and very costly to prototype & manufacture with traditional fabrication methods. Additive Manufacturing (AM), also known as “3D Printing,” “Layered Fabrication,” “Rapid Prototyping,” “Additive Fabrication,” or “Layered Manufacturing,” is a fabrication methodology which provides the ability to readily fabricate these previously impossible features in a fast, accurate, and cost-effective way. Subtractive machining practices like milling and turning remove waste material until only the part features remain. AM is a maskless process that fabricates a three-dimensional object from the base up by adding thin consecutive cross-sectional profiles of the object which bind together for a complete 3D shape. This is fixtureless fabrication since no new tooling is required and although there are many different fabrication materials, machines, and procedures worldwide, the nature of these technologies remain similar.

The unique capabilities of Additive Manufacturing have benefitted the engineering design process in reduced development time & cost, greater variety in a family designs, and prototypes more accurate to functional testing of the final device. The normally long time periods between design iterations for form and fit evaluation can be significantly reduced with AM, so depending on part size it may take only a few hours to go from digital design to physical part. These factors make the technology excellent for custom parts produced to order in small quantities. Virtually all layered processes can deposit material in the horizontal plane much more rapidly than they can build up thickness. Consequently parts are typically built lying down so that their shortest overall dimension is oriented along the z-axis to optimize for build time. Parts are also frequently nested within the build chamber to maximize parts per build cycle.

FIG. 1 (available at http://www.custompartnet.com/wu/images/rapid-prototyping/fdm-small.png) shows main elements of Fused Deposition Modeling (FDM) system, which is a type of additive manufacturing system. A heated extrusion head receives materials in filaments and uses heat to liquefy the material, e.g., plastics, and deposit them in a layer on a build platform. When the system finishes printing one layer, the system lowers the platform, where the printed object is located, and prints another layer. This figure shows an extrusion head 101 that moves in the X-Y plane and a heated build platform 102 that moves in the Z plane. The extrusion head 101 includes one nozzle 103 for support material, one nozzle 104 for build material. The build material is typically thermoplastic modeling material that enters the system from spools 104 and 105 and feeds into the temperature controlled FDM extrusion head 101. The thermoplastic modeling material is pulled by drive wheels 106 and passed into liquefiers 107 that heat the material. The heated material is extruded on to the build platform 102 by extrusion nozzles 103 and 104. After each layer of material has been deposited, the build platform 102 is moved down and the next layer of material is deposited. A motor system (not shown) provides force to drive wheels 106. Additional motors control the X-Y-Z location of the extrusion head 101 and heated build platform 102.

Current Additive Manufacturing processes do not support the direct fabrication of objects that contain embedded electronics or sensors. Methods have been suggested which allow the user to pause the build cycle of the machine and pick and place off-the-shelf mechanical or electrical components into pre-designed cavities. For standard components this is labor-intensive but functional, however for fabricating custom or non-planar sensors inside the structure of the produced part this not feasible. For components which are non-planar and need to be routed/connected in all three axes (for example such as wires with curved trajectories, cylindrical & helical features such as induction coils, or measuring strain across several planes like within an airfoil, turbine blade, or device which superficially interfaces with anatomical features) a manually-intensive two-step process used.

First the object must be completely fabricated with a series of specifically designed channels (or voids). Next, a conductive material is manually injected using a syringe into the channels (or voids) of the object and allowed to cure. This requires that the part be designed and fabricated with injection ports on the outside of each of the conductive channels which lock into the syringe to provide an adequate seal. Programming and 3D printing of the object occurs entirely before the conductive material is added. As the conductive material is pushed along the pathways the reliability of complete filling is questionable from sharp bends and bifurcations in the channels. Therefore, the spaces need to be as open as possible, the interior diameter large as possible, and any turns under 100 degrees be avoided. Additionally, after the injection of the conductive material, the injection locks need to be broken away and the residual surfaces need to be polished. This accomplishes the goal of embedding electronics in the components but with significant limitations and uncertainties.

This method of manufacturing has many limitations. It can be difficult to force the silicone all the way through a complicated channel without breaking the path of the silicone at any point, or causing irregularities and uneven areas. The likelihood of breaks in the circuit increases with more complicated cavities (this includes paths that take multiple turns, bends 100 degrees or smaller, or interior diameters which are under 1 mm diameter). Multiple entries and exits in a cavity cause differences in pressure for each pathway, further increasing the likelihood of an incomplete fill of the cavity. This process is also messy. Manual injection can be inefficient and unreliable. The reliability is affected because the conductive material must be injected completely through the cavities to conduct a signal, which can be difficult to achieve. When trying to inject along an internal channel, the high shear friction along the walls can cause a material to stop moving, yielding an cavity that has not been completely filled.

FIG. 4A shows a cross sectional view of a fabricated object with channels (or voids) to illustrate the injection process of conductive material. The fabricated object has material 403 and voids 404. The layout of voids 404 creates a channel for a conductive material to be added. Extrusion head 401 uses injection lock 405 to inject the conductive material 402 through an entrance of voids 404. A close up of the injection lock feature is shown in FIG. 4B. To reduce spillage when injecting a conductive material into a channel, an extrusion head is attached to a Luer Lock 405 with a tube 407. Typically, a Luer Lock is attached to a syringe using a threaded element 406. The material is injected through the tube 407 into the interior channels of a fabricated object.

FIG. 5A is a picture of an object where the conductive material has been injected into interior channels and allowed to cure. FIG. 5B shows the exterior of an object where extra conductive material is present at the injection points. This spillage occurs in the absence of a proper seal between the extrusion head and the entrance to the interior channels in the object.

FIG. 6A shows a fabricated object with plastic materials of two colors that have similar material properties. Unlike using materials with similar properties, fabricating an object with different material properties, is difficult to achieve. For example, the deposition method for ABS plastic is very different from the deposition method for a conductive silicone solvent-based suspensions. In addition the solid/liquid material flow properties and required curing conditions for ABS plastic are very different from those of a conductive silicone solvent-based suspension. FIG. 6B shows a fabricated object using two material (plastic and conductive silicone) that have different material properties. In this example the conductive silicone is incompletely cured or solidified. During deposition of the conductive silicone a balance is required such that material cures quickly (to improve the fabrication time), but also slowly enough that the material does not cure while before being fully deposited into the deposition channel.

### BRIEF SUMMARY

In one aspect, the invention is a system for fabricating a three-dimensional object with electrical properties where the system includes a build chamber, a build platform disposed within the build chamber, and a deposition head disposed within the build chamber configured to deposit a first material onto the build platform and further configured to deposit a second material with electric properties onto the build platform. The system may also include a memory for receiving data representing a three dimensional object and a controller for forming a layer of material, adjacent to any last formed layer of material, accordance to the data representing the three dimensional object, where the controller is operable to selectively control the deposition of the first and second material within the layer.

In one aspect, the invention further includes a reservoir capable of containing a material with electrical properties, at least one motor assembly configured to impart a force on an actuator, a controller configured to control the motor assembly, a deposition nozzle in fluid contact with the interior of the reservoir, where the actuator imparts a force on the material; and where at least some portion of the material is expelled from the reservoir.

In one aspect, the invention includes a motor that drives a lead screw and nut assembly. In one aspect, the invention includes a motor that drives a pinion of a rack and pinion system. In one aspect, the invention includes a motor that drives an auger.

In one aspect, the invention includes a reservoir that is directly mounted on the deposition head of a 3D printer. In one aspect, the invention includes a reservoir that is mounted on the exterior of a 3D printer. In one aspect, the invention includes a reservoir that is mounted on a mechanically grounded frame above the 3D printer.

In one aspect, the invention is attached as a tool head on a numerically controlled or computer numerically controlled system. In one aspect, the invention is attached as a tool head on a drill press.

In one aspect, the invention includes a nozzle design that reduces the force required to expell high viscosity material from the reservoir. In one aspect, the environmental conditions, including temperature or pressure, of the nozzle can be controlled by the controller.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 illustrates the main elements of a Fused Deposition Modeling (FDM) system.

FIG. 2A illustrates the Makerbot Replicator 1 3D printer.

FIG. 2B illustrates the RepRap Prusa Open Source 3D printer.

FIG. 3 illustrates the Cubify 3D printer.

FIG. 4A illustrates the process of injecting conductive material into an object fabricated with channels (or voids).

FIG. 4B illustrates an injection lock used during the injection of conductive material.

FIG. 5A is a picture of an object where the conductive material has been injected into interior channels and allowed to cure.

FIG. 5B is a picture of an object where extra conductive material is present at the injection points.

FIG. 6A shows an object fabricated with plastic materials of two colors that have similar material properties.

FIG. 6B shows an object fabricated with two material that have different material properties.

FIG. 7A is a process flow diagram for using a 3D printer to create an object with embedded electrical connections.

FIG. 7B is a process flow diagram for using the Embedded Electronics by Layered Assembly (EELA) system to create an object with embedded electrical connection.

FIG. 8A is a side view showing the deposition of conductive material.

FIG. 8B is a side view showing the deposition of non-conductive material.

FIG. 9A is an isometric view of the Embedded Electronics by Layered Assembly (EELA) system integrated with a 3D printer.

FIG. 9B is an exploded view of the Embedded Electronics by Layered Assembly (EELA) system integrated with a 3D printer.

FIG. 10 shows one embodiment of the Embedded Electronics by Layered Assembly (EELA) system.

FIG. 11 shows the operation of the Embedded Electronics by Layered Assembly (EELA) system.

FIG. 12 is a cross section view of connection between a material reservoir and an impermeable transfer tube.

FIG. 13 is the feedback loop for the Embedded Electronics by Layered Assembly (EELA) controller.

FIG. 14 illustrates a slider and nut assembly.

FIG. 15 illustrates a plunger reinforcement slug.

FIG. 16 illustrates a syringe reinforcement housing.

FIG. 17 illustrates a plunger reinforcement fitting.

FIG. 18 is an isometric view of one embodiment of an Embedded Electronics by Layered Assembly (EELA) system integrated with a 3D printer.

FIG. 19 is an isometric view of one embodiment of an Embedded Electronics by Layered Assembly (EELA) system integrated with a 3D printer.

FIG. 20A is a side view of a miniature motorized syringe design.

FIG. 20B is a cross section view of a miniatures motorized syringe design.

FIG. 21 illustrates an internal helical plunger mechanism.

FIG. 22 is a cross section view of a conductive material reservoir.

FIG. 23 is an isometric view of one embodiment of an Embedded Electronics by Layered Assembly (EELA) system integrated with a drill press.

FIG. 24 is an isometric view of one embodiment of an Embedded Electronics by Layered Assembly (EELA) system integrated with a mill.

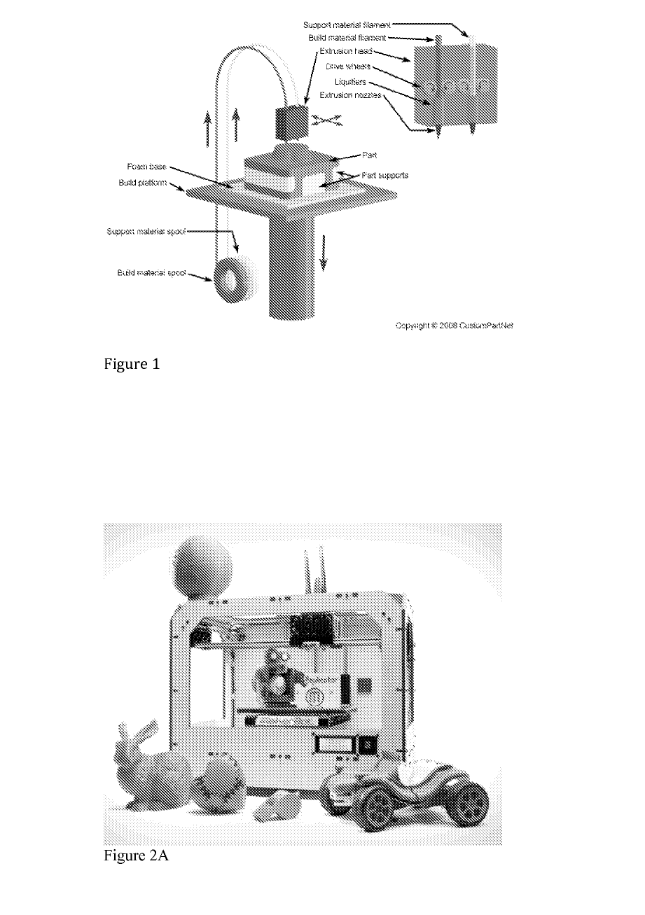

### DETAILED DESCRIPTION

The Embedded Electronics by Layered Assembly (EELA) system is a motorized extruder that can be used to extrude a piezoresistive elastomer, such as a conductive silicone compound, into channels built during the additive manufacturing process on a 3D printer. The EELA system enables the building of conductive circuitry directly into an object while the object is being printed, rather than requiring the injection of the conductive material after the 3D printing is completed. The EELA system is capable of more fine-tuned and precise movements than a person can make with a syringe, and since printing and extrusion occur together, the EELA system may easily reach all areas of the conductive path in the object since it has access to the cross section of each layer during the build. This eliminates the potential problems described above and requires less overall work during manufacturing. Additionally, this can help to standardize the process of embedding conductive materials.

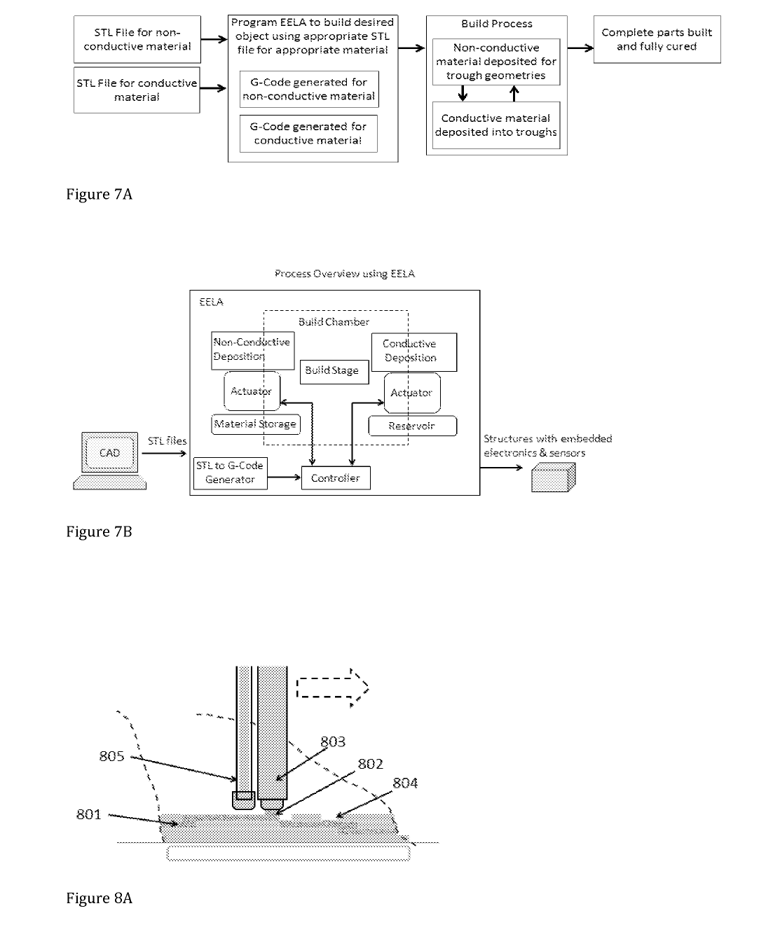

FIG. 7 is a process flow diagram for using the Embedded Electronics by Layered Assembly (EELA) system to create an object with embedded electrical connection. When the Embedded Electronics by Layered Assembly (EELA) system is integrated with a 3D printer the number of steps to fabricate an object is reduced. The injection of the conductive silicone is no longer performed by hand. Instead the conductive silicone is extruded during the fabrication process itself.

In one embodiment, the first step in fabricating an object is to define the object in a computer aided design file. This file defines the 3D geometry of the object to be fabricated. One well known file format is the STL (STereoLithography) file format; however, any file type that can contain geometry information, such as .svg, .dxf, .cmp, .sol, .plc, .sts, .stc, .gtl and *.jpg, may potentially be used. One geometry file is used for the non-conductive (thermoplastic) features. A second geometry file is used for the conductive material. The two geometry files are then integrated and converted into a set of commands to move the extrusion head, move the build platform, and actuated the mechanism to deposit the thermoplastic/silicone material. One well known converter is ReplicatorG which will take the input geometry file and generate GCode commands. GCode is a well known numerical control programming language, that allows for the control of the position of the extrusion heads, the speed at which the heads move, and the temperature of the nozzles and build platform. The GCode is then executed. The thermoplastic will be extruded leaving gaps or troughs for the conductive silicone. The silicone is then deposited into the gaps. This process continues layer by layer until the object is completely fabricated.

In one embodiment, the Embedded Electronics by Layered Assembly (EELA) system is integrated into the 3D printing system electronically and mechanically, and is software-compatible. FIG. 7B is a process flow diagram where the Embedded Electronics by Layered Assembly (EELA) system fully integrated with the 3D printing system. The controller 701 uses the GCode commands to control the position of the non-conductive extrusion head 702, the position of the non-conductive extrusion head 703, the position of the build platform, as well as the deposition rate of the thermoplastic and conductive material. After the thermoplastic and conductive materials have been deposited, the finished object can be removed from the build chamber. Position and pressure feedback loops allow the controller to precisely deposit the conductive silicone at the required locations within the build chamber.

FIGS. 8A and 8B show side profile views of the conductive deposition system 803 moving along the XY build plane and depositing non-conductive material and uncured conductive material 802. A non-conductive deposition system 808 uses a heated nozzle 807 to deposit non-conductive material. Then the conductive deposition system 803 will become active and place conductive material 802 in any open layer spaces 804 (i.e., spaces where no non-conductive material is deposited) that have been formed in the current layer. This uncured conductive material 802 will cure when exposed to air and form the conductive material layer 801. The thickness of uncured conductive material 802 deposited is equal to or similar to the layer thickness of the open layer spaces 804. The non-conductive deposition system 805 and conductive deposition system 803 are contained in the same extrusion head and thus move together, but only one of the conductive and non-conductive deposition systems extrudes its material at any one point in time. Alternatively, the two deposition systems can be placed in two separate extrusion heads for independent operations. In this example, the conductive deposition system can concurrently extrude a conductive material as the non-conductive deposition system deposits its material. Once one layer has been completely deposited, the next layer will be formed. The process repeats until the object is fully formed.

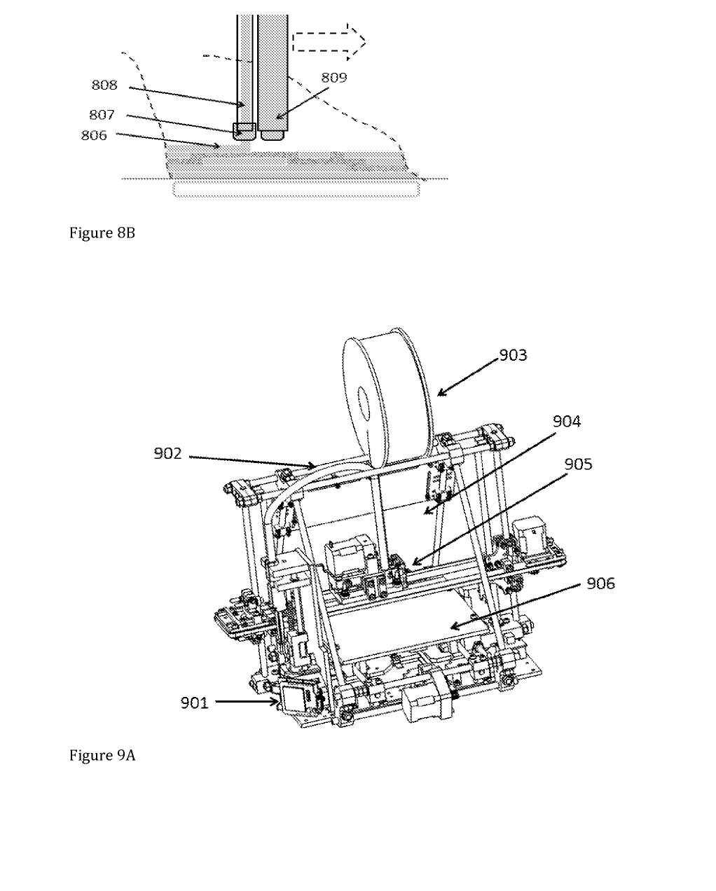

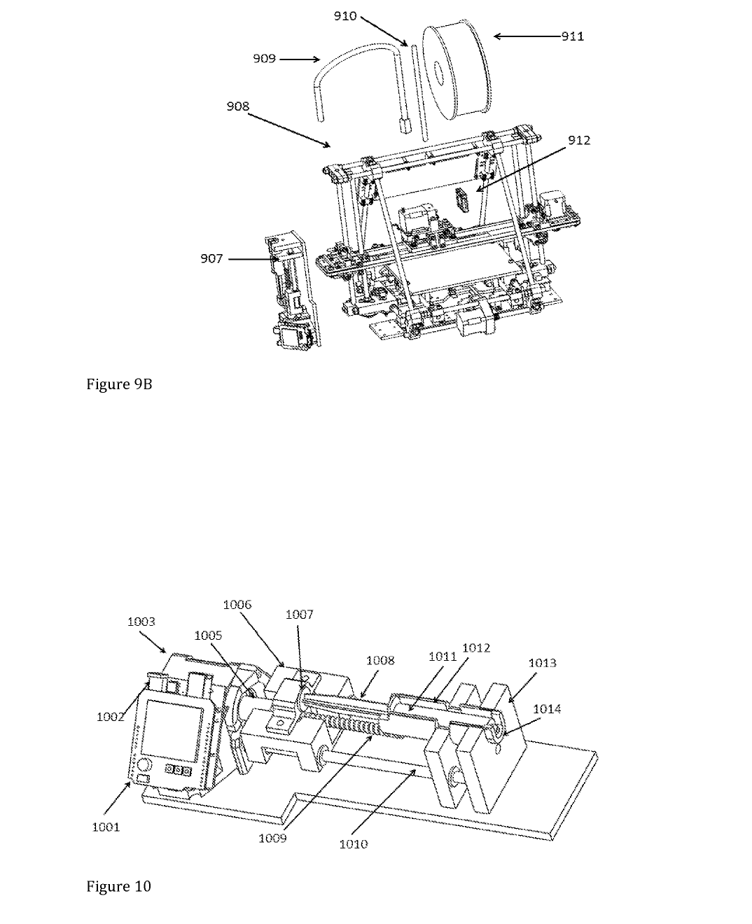

FIG. 9A shows one embodiment of the EELA system 901 attached to a 3D printer 902. The 3D printer has an on-board non-conductive material storage 903, internal build chamber 904, motorized deposition system 905, and heated build platform 906. The EELA system 901 integrates with the 3D printer 902 to control the motorized deposition system 905 so that components with embedded electronics can be fabricated within the internal build chamber 904. FIG. 9B shows the EELA extrusion mechanism 907 connected to flexible tubing 909 that allows the conductive material to be deposited within the internal build chamber 904. Similarly, The non-conductive material 911 is guided to the motorized deposition system 912 via its own flexible guide 910. The location of deposition of the conductive material is controlled by the EELA system 901 sending signals to the motorized deposition system 905 of the 3D printer 902. The temperature on the motorized deposition system 905 is regulated by a fan and thermal sensor 912.

3D Printing System

In one embodiment the 3D printing system uses Fused Deposition Modeling (FDM) to create layers of material by extruding beads of molten thermoplastic, which bond as they contact the part surface and immediately cool. FDM can utilize many compositions of plastic—the most common being ABS, Polycarbonate, Polylactide, or a combination.

In one embodiment, the 3D printing system 102 is a MakerBot Replicator, but the EELA system can be used with a variety of 3D printer hardware configurations. Example 3D printing systems are listed in Table 1. Each of the 3D printers listed extrude only non-conductive materials and can be used in conjunction with the EELA system to extrude conductive silicone for internal electronic circuits in the fabricated object.

| Manufacturer | Model | Price | Materials | Strengths | Weaknesses |
|---|---|---|---|---|---|
| MakerBot | Replicator | $1,749/$2000 | PLA, ABS | Low cost; high | Slow process |
| | (single or | | plastic | adaptability; | |
| | dual | | | open source; can | |
| | extrusion) | | | extrude 2 colors | |
| | (Commercial/ | | | or materials | |
| | Open Source) | | | simultaneously | |
| MakerBot | Thing-O- | $2500 | PLA, ABS | Low cost; high | Slow |
| | Matic | | plastic | adaptability; | process; low |
| | (Commercial/ | | | heated build | resolution |
| | Open Source) | | | platform; open- | |
| | | | | source | |
| Reprap | Mendel | $520 (kit) | PLA, | Lowest cost; | Slow |
| | (Open | | HDPE, | high adaptability | process; not |
| | Source/ | | ABS | | user- |
| | Hobbyist) | | plastic | | friendly; low |
| | | | | | resolution |
| | | | | | finish |
| BotMill | Glider | $1,395 | PLA, ABS | Low cost; user- | Slow process |
| | | | plastic | friendly | |
| MakerGear | M2 | $1,299 | PLA, ABS | Low-cost; | Slow |
| | | | plastic | compact size; | process; low |
| | | | | low maintenance | resolution |
| MakerGear | Prusa Mendel | $825 | PLA, ABS | Low-cost; | Slow |
| | | | plastic | compact size; | process; low |
| | | | | low maintenance | resolution |
| Fab @ | Model 1 & 2 | $2400/$1600 | silicone | Low cost; | Limited |
| Home | (Open | | rubber | compact size; | workspace; |
| | Source/ | | caulk; | many material | accuracy |
| | Hobbyist) | | epoxy; | options | depends on |
| | | | many | | material |
| | | | household | | |
| | | | materials | | |
| 3D Systems | Rapman 3.2 | $1,390 | Plastic | Low-cost; | Slow process |
| | | | polymer | compact size; | |
| | | | | user-friendly | |
| 3D Systems | Cube | $1,299 | Recyclable | Able to make very | Single |
| | | | plastic | complicated | material/color |
| | | | | structures; can | printing at a |
| | | | | print from Wi-Fi; | time |
| | | | | easy to load new | |
| | | | | color cartridges | |
| Stratasys | uPrint ™ SE | $13,900/$18,900 | ABS plastic | Strong, durable | Slow process; |
| | and Plus SE | | with soluble | parts; | relatively |
| | (Commercial) | | supports | FDM reliability; | expensive |
| | | | | quiet and clean | material |
| Hewlett | DesignJet 3D | $17,000/$22,000 | ABS plastic | Strong, durable | Slow process; |
| Packard | Printer | | with soluble | parts; | relatively |
| | (Color option | | supports | FDM reliability; | expensive |
| | available) | | | quiet and clean | material |
| | (Commercial) | | | | |

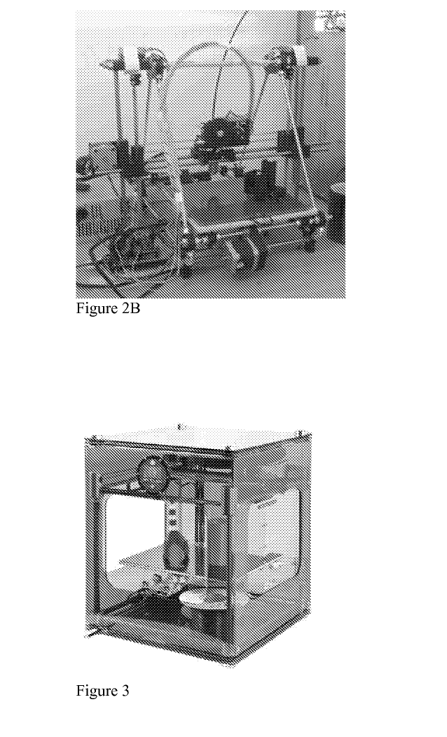

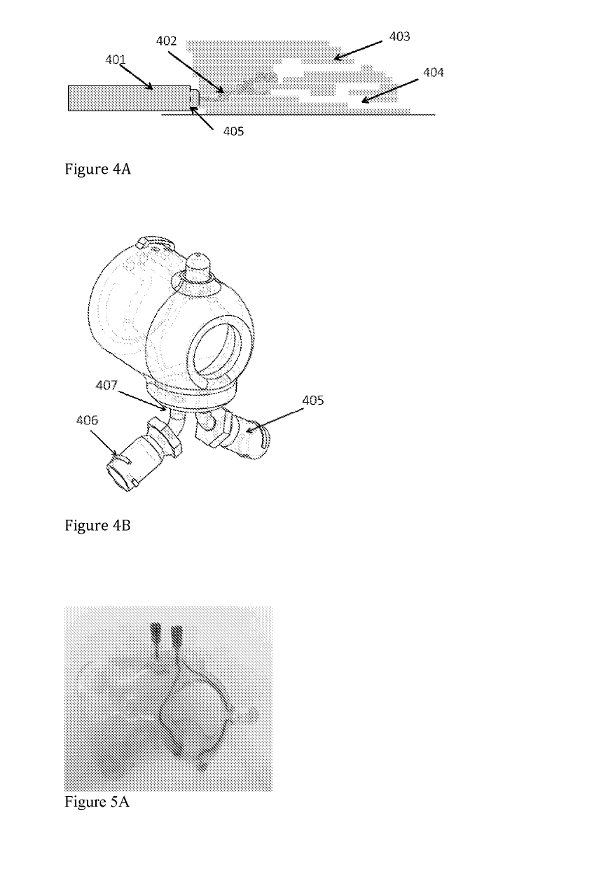

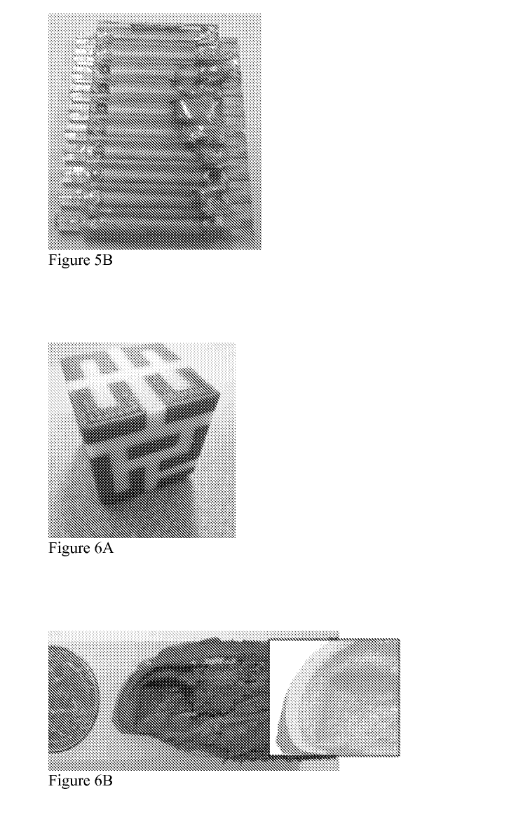

FIGS. 2A, 2B and 3 show examples of commercial 3D printers that can be used with the EELA system. FIG. 2A is the Makerbot Replicator 1 available from the Makerbot Store and additional details are available at http://store.makerbot.com/replicator.html. FIG. 2B is the RepRap Prusa Open-Source System and additional details are available at the RepRap Mendel Design Wiki ad http://reprap.org/wiki/Prusa_Mendel_(iteration_{—}2). FIG. 3 shows a 3D touch system sold by by Cubify 3D systems and additional details are available at http://cubify.com.

Embedded Electronics by Layered Assembly (EELA) System

FIG. 10 shows one embodiment of the EELA extrusion mechanism 907. The EELA extrusion mechanism 907 is actuated by stepper motor 1005 that drives threaded rod 1009. The threaded rod 1009 is supported by motor stop 1005 and slider stop 1013. A pair of guide rails 1010, mounted parallel to the threaded rod 1009, is also supported by motor stop 1005 and slider stop 1013. A nut (not shown) is embedded in slider 1006 and is held in place by syringe guide block 1007.

One end of syringe feed shaft 1008 is mounted in syringe guide block 1007. The other end of syringe feed shaft 1008 is attached to one end of syringe 1011. The other end of syringe 1011 is mounted in syringe support 1013. The syringe support 1013 is held in place by slider stop 1013. An impermeable tube (not shown) connects the syringe 1011 to extrusion head (not shown). A fluid impermeable seal, such as a friction fit Luer Lock Barb, is used to connect the material reservoir in the syringe 1011 to the flexible tube channel with a tight seal.

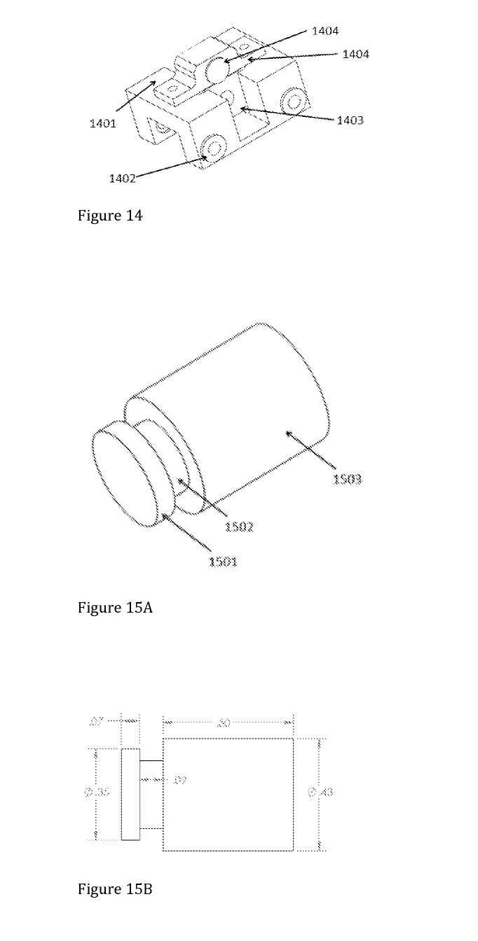

FIG. 14 shows one slider 1401 and nut 1403 mounted together. Nut 1403 is held in place in slider 1401 by grooves (not shown) and cannot rotate with respect to slider 1401. Nut 1403 is prevented from sliding out of the grooves by syringe guide block 1404. Slider 1401 also includes a series of bushings 1402 which allow slider 1401 to move along the guide rails 1010. A pressure sensor 1405 is mounted on the syringe guide block 1404. The pressure sensor measures the pressure applied to the syringe 1011 via syringe feed shaft 1008 and the pressure measurement is used to precisely control force applied to the syringe.

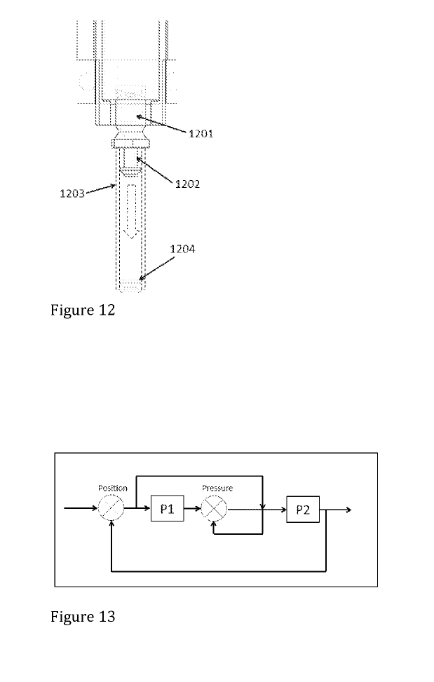

FIG. 12 shows the details of the connection between the end of the reservoir end 1201 of the syringe and the impermeable tube 1203. In one embodiment a friction fit Luer Lock Barb 1202 is used to connect the reservoir end 1201 of the syringe and the interior of the impermeable tube 1203. The Luer Lock Barb 1202 provides a fluid impermeable seal which prevents the silicone in the reservoir and impermeable tube 1203 from being exposed to air and curing inside the EELA system. In one embodiment the impermeable tube 1303 would contain a valve-nozzle combination. The valve portion of the valve nozzle would seal the nozzle when the system was not in use. An alternative option is to use a small threaded plug 1204 that can be manually screwed onto the tip of the impermeable tube 1203 to seal off the silicone path when the 3D printer is not in use. Another alternative option is to direct the extruder to clean nozzle of any material left in it from the last print prior to starting the build of a new object. This will ensure that no cured or crusted silicone inside the nozzle interferes with the build of a new object.

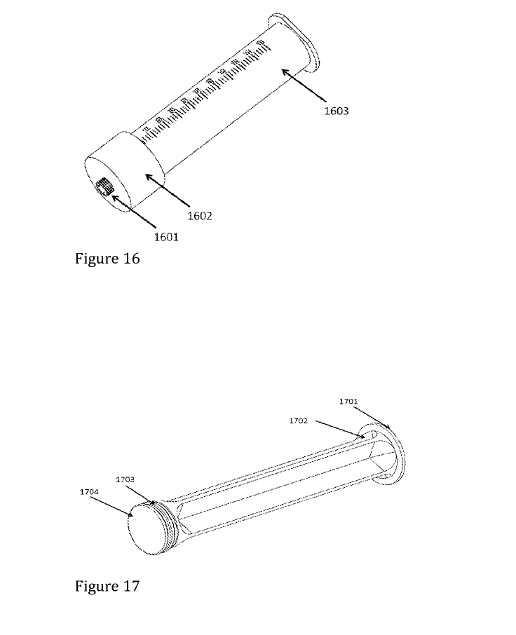

FIGS. 15, 16, and 17 shows the details of the syringe, plunger, and plunger plug. To use the syringe (FIG. 16) for the injection of silicone, the plunger on the end of the plunger (FIG. 17) is replaced with a smaller plunger reinforcement slug that screws over the end of the plunger rod. FIG. 15 shows the plunger plug. In one embodiment, the plug is part is slightly longer than half an inch, with a diameter of 0.43″ at its thicker end. The slug bottlenecks before flattening into a plunger end that fits inside the syringe passageway, with a diameter of 0.35″. The exact size of this piece is very important; if it is slightly too small, silicone may leak out the back of the syringe, flowing around the rubber reinforcement that is placed over the end of the plunger.

Referring again to FIG. 10, slider 1006, and therefore nut 1403, cannot rotate with respect to stepper motor 1005 that drives threaded rod 1009 because of guide rails 1010. When stepper motor 1005 drives threaded rod 1009, nut 1403, and therefore slider 1006, will move longitudinally along threaded rod 1009. As slider 1006 moves along threaded rod 1009, the syringe feed shaft 1008 will depress the plunger in syringe 1011 forcing the material in the syringe through the impermeable tube (not shown) and into the extrusion head.

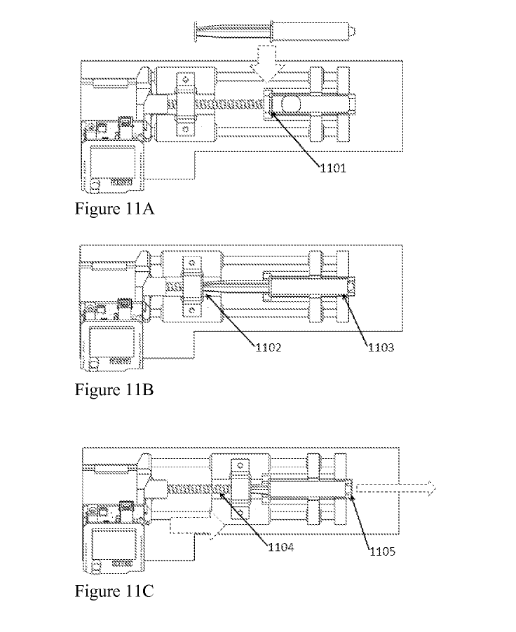

FIGS. 11A, 11B, and 11C shows the slider moving longitudinally along threaded rod 1104. In FIG. 11A the slider is retracted and located at the end of the threaded rod 1004 near the stepper motor. The syringe can then be inserted into the assembly. FIG. 11B shows the syringe in the assembly. The pressure sensor 1102 is mounted on the syringe guide block and measures the longitudinal pressure applied to the syringe. FIG. 11C shows the stepper motor rotating the threaded rod 1104. This causes the slider to move along the treaded rod 1104 applying force to the syringe feed shaft. The contents of the syringe is extruded through the syringe outlet 1105. Any mechanism that creates a linear force could be used as an alternative to the stepper motor, threaded rod, nut, and slider. Alternative examples include a rack and pinion, a crank and rocker, or a rack and pinion.

FIG. 13 shows the details of the controller for the conductive deposition system. In order to control the deposition rate of the conductive material, the controller must be able to control the stepper motor that provides the linear force on the syringe. Position and pressure feedback loops, shown in FIG. 13, allow the controller to precisely deposit the conductive silicone at the required locations within the build chamber. The controller sends commands to the actuator to extrude the conductive material, while using a pressure sensor to monitor the pressure in the system. In addition the controller monitors the position of the syringe plunger according the number of rotations of the stepper motor via encoder or potentiometer. It monitors the backpressure on the syringe using a force sensor (such as thin film force sensor) and stops the motor turning if the pressure passes a set thread hold. The set thread hold is indicative of a clog in the syringe and stops the motor to avoid damaging the syringe seal.

The conductive material can be a conductive silicone compound or any other piezoresistive elastomer, silver ink, platinum ink, iron filings compound, conductive rubber, copper, graphite/nickel suspension, or tin particle suspension that does not require vulcanizing conditions with high pressures and temperatures above the creep values for thermoplastics used to build the object. In one embodiment the conductive compound is a silicone room-temperature-vulcanizing (RTV) material containing conductive particles of nickel-coated graphite, for example MMS-020 available from Moreau Marketing & Sales, Lexington NC. This material is representative of a group of Room Temperature Vulcanizing (RTV) materials which cure by degassing a solvent reaction inhibitor. Common single part solvent-based epoxies include cyanoacrylite instant adhesive “Crazy Glue” and DWP-24 Wood Adhesive “Liquid Nails.” When in the sealed environment of the syringe, the material remains in a liquid state because the trapped solvent inhibits the curing process. But when applied to a surface, the solvent inside the liquid escapes into the surrounding atmosphere and the epoxy molecules cross-knit and pull together to form chains. When conductive graphite is suspended inside this material the end state is that these particles are close enough together to allow electrons to jump from one to the next when fitted into a circuit with a voltage differential. Combining this silicone with graphite adds the piezoresistive response when the particles are strained apart. Silicone is a good elastomer for the suspension because it is abundant, inexpensive, and thermally stable.

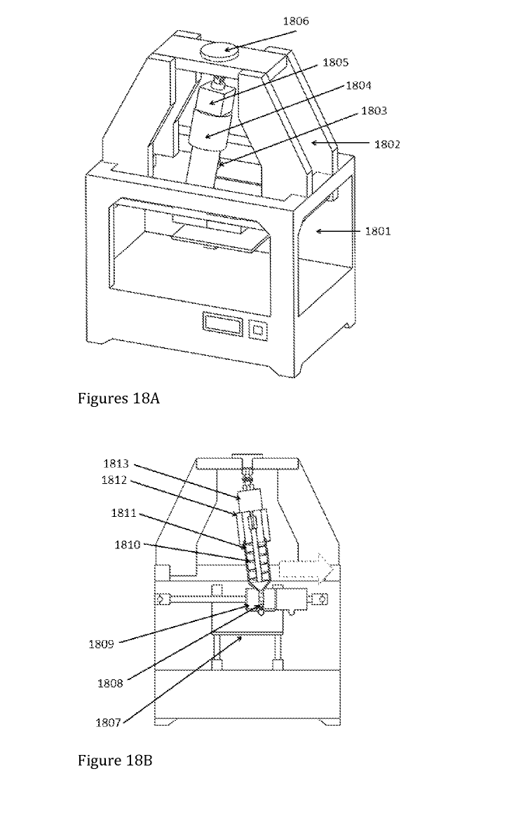

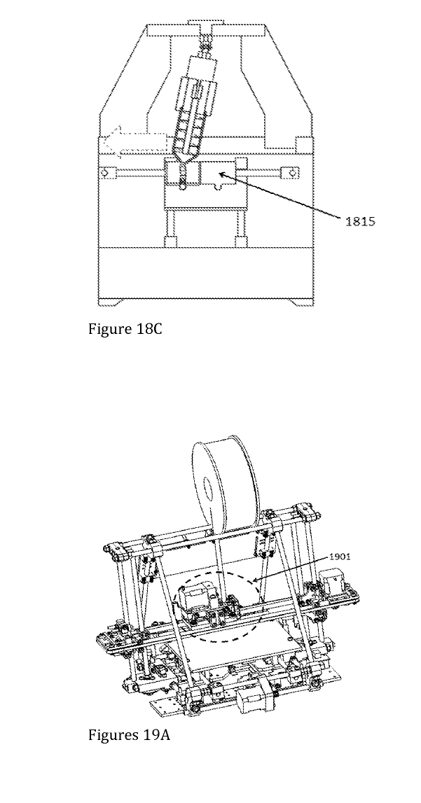

FIG. 18A shows one embodiment of the EELA system attached to a 3D printing system. The EELA system is mounted on a frame 1802 above the build chamber 1801 of the 3D printing system. A reservoir 1804 contains the conductive material and is in fluid connection with an auger chamber 1803. The conductive material flows from the reservoir 1804 through the auger chamber 1803 and into the to the extrusion head in the build chamber 1801. A stepper motor is attached to the reservoir 1804. The stepper motor 1805, the reservoir 1804, and the auger chamber 1803 are attached to the frame 1802 by joint 1806. The joint 1806 may be a ball and socket, universal joint, or any other joint type that allows stepper motor 1805, the reservoir 1804, and the auger chamber 1803 to move in the X-Y direction during the fabrication process.

FIG. 18B shows a cross section view of the EELA system mounted on a frame above the build platform 1807 of the 3D printing system. The interior of reservoir 1811 contains an auger 1810 that is driven by stepper motor 1812. Auger 1810 is used to control the flow rate of the conductive material through the tapered extrusion point 1808 in the conductive deposition extrusion head 1809. This design allows for a large reservoir of conductive material to be located close to the extrusion head 1809. Because the weight of the reservoir is not supported by the extrusion head 1809 the inertia of the extrusion head 1809 does not change and no changes to the standard control logic for the extrusion head 1809 are required. In this figure the extrusion head 1809 has been moved to the far right of the build platform 1807.

FIG. 18C shows a cross section view of the EELA system mounted on a frame above the build platform 1807 of the 3D printing system, where the extrusion head has been moved to the far left of the build platform 1807. This figure also shows the non conductive extrusion head 1815 that heats the thermoplastic modeling material to a semi-liquid state. The thermoplastic modeling material is then expelled from the extrusion head and deposited on the object on the build platform within the build chamber. The build chamber is a heated space, maintained at a temperature just below the material's melting point. Within the build chamber when one layer of liquid plastic contacts the semi-molten layer beneath it they will harden together as the two layers bind. After the extruder has completed the cross-section of the object in the X-Y plane, the build platform drops one layer thickness for the next profile.

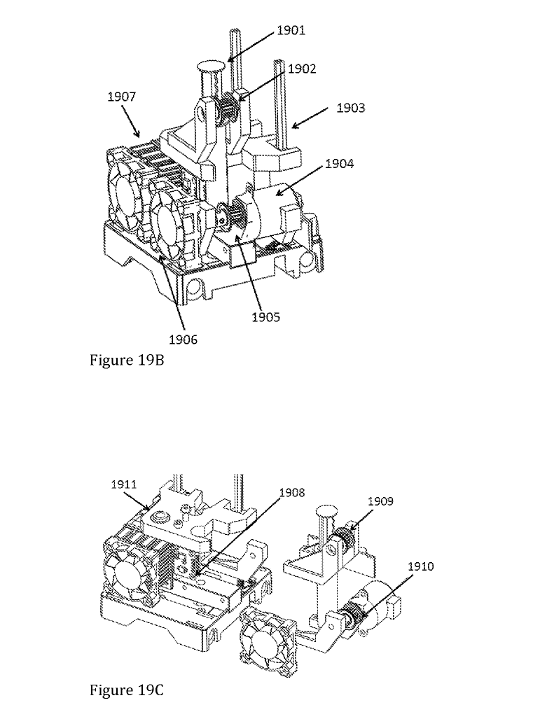

FIG. 19A shows one embodiment of the EELA system attached to a 3D printing system. In this embodiment the entire EELA system is mounted on the moveable extrusion head in the 3D printing system. FIG. 19B shows the details of this embodiment of the EELA system. A rack 1901 and pinion 1902 provides a linear force that is applied to the reservoir that contains the conductive material. The pinion 1902 is a circular gear with teeth that engage the teeth on the rack 1901. When the pinion rotates the rack 1901 moves, thereby translating the rotational motion of the pinion 1902 into linear motion of the rack 1901. The stepper motor 1904 is connected to pinion 1902 via a pulley 1905 and pulley belt (not shown). Fan 1906 is used to control the temperature of the conductive material as it is extruded. FIG. 11C shows a exploded view of the EELA system mounted on extrusion head, including pulley 1910 and pinion 1909.

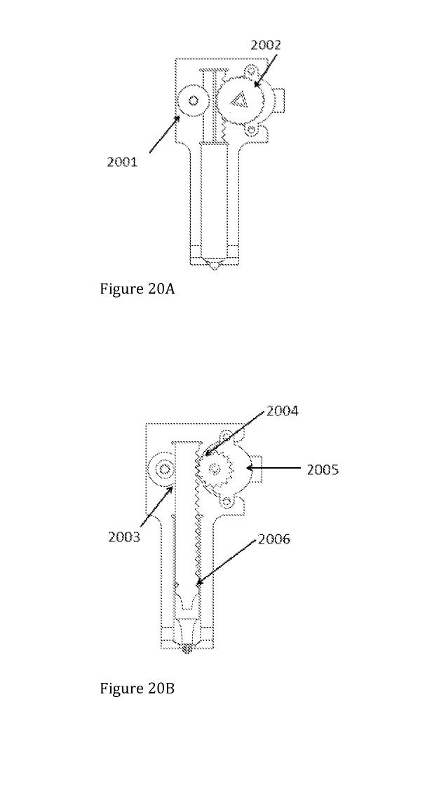

FIG. 20A is a side view of one embodiment of the EELA system. FIG. 20B is an interior cross section view of one embodiment of the EELA system. FIGS. 20A and 20B show a miniature motorized syringe design where a rack and pinion 2004 interfaces with the syringe plunger 2003 to extrude material. An on-board stepper motor 2005 drives the rack and pinion 2004 to move the syringe plunger 2003. The opposite side the syringe plunger 2003 is held in place by an idler pulley 2001 for alignment. Within the syringe plunger 2003 there is an O-ring 2006 to create a pressure seal during extrusion.

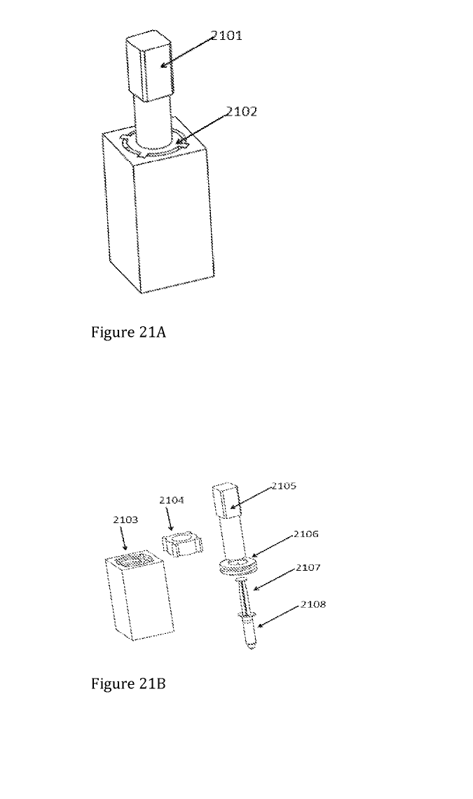

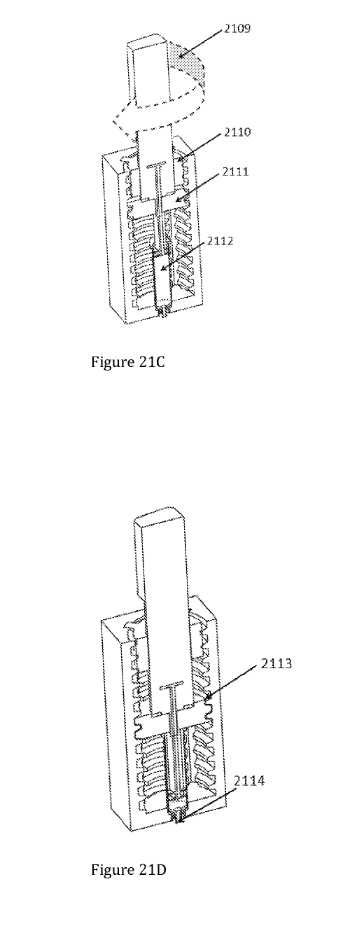

FIG. 21 shows the internal helical plunger mechanism which consists of a static assembly 2101 and a moving assembly 2102. This mechanism has a threaded housing 2103 which holds the syringe 2108, plunger 2107, rotating nut 2106, and fixed lock 2104, and drive shaft 2105. A rotational force 2109 is applied to the drive shaft 2105 to actuate the mechanism. The rotating nut 2111 moves along the interior of the threaded housing 2104 to apply force to extrude through the syringe 2112. The fixed lock 2110 interlocks with the threaded housing to prevent it from turning but not from supporting. As the rotating nut 2113 moves down along the threaded housing 2103, conductive material is extruded out of the syringe 2114. FIG. 21C shows the plunger fully retracted. FIG. 21D shows the plunger fully extended.

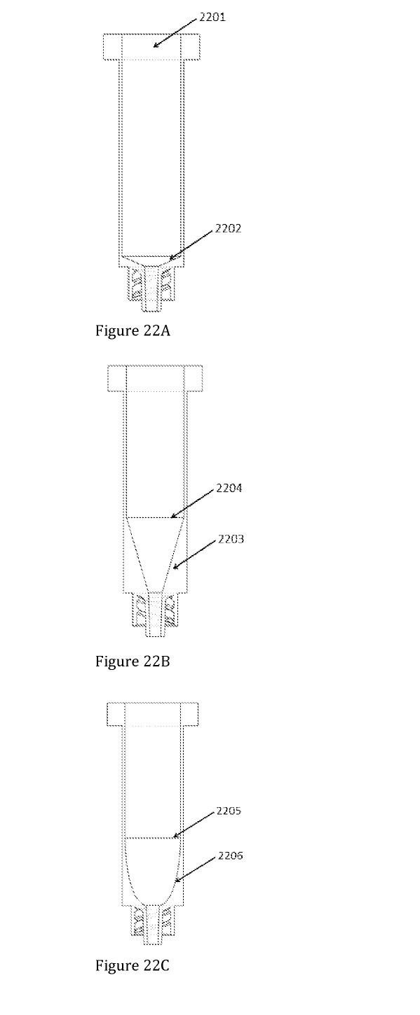

FIG. 22A shows a cross-section view of the conductive material reservoir 2201 for extruding conductive suspensions of low viscosity. The shallow taper contour 2202 is a straight chamfer. For extruding higher-viscosity materials, the shallow taper contour 2202 may alternatively be a deep tapered contour 2203, as shown in FIG. 22B. The deep tapered contour edge height 2204 indicates the boundary of the deep tapered contour 2203. For extruding higher-viscosity materials, the shallow taper contour 2202 may alternatively be a elliptical contour 2206, as shown in FIG. 22C. The elliptical contour edge height 2206 indicates the boundary of the elliptical contour 2206.

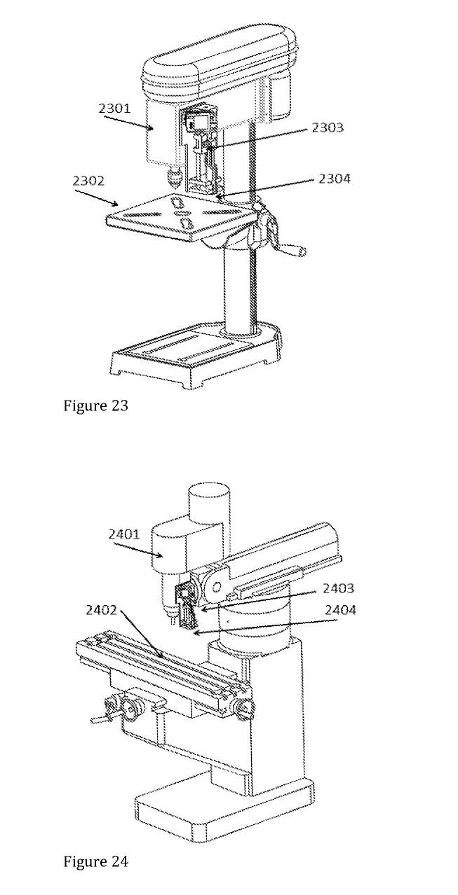

The conductive deposition unit can be used with systems other than traditional 3D printers. FIG. 23 shows the EELA conductive deposition system 2303 mounted to the exterior of a drill press 2301. The extrusion site 2304 is able to add conductive material to components which are placed on the drill press platform 2302. The height of the EELA conductive deposition system 2303 above the drill press platform 2302 is adjusted according to the type of part (not shown) which will receive the conductive injection. FIG. 24 shows the EELA conductive deposition system 2403 mounted to the exterior of a mill 2401. The extrusion site 2404 is able to add conductive material to components which are placed on the mill bed 2402. The height of the EELA conductive deposition system 2403 above the mill bed 2402 is adjusted according to the type of part (not shown) which will receive the conductive injection.

1. A method of constructing a object from a plurality of layers, comprising:
depositing a first material in a predetermined arrangement to form a first layer, wherein the depositing results in at least one channel occurring within the first layer;
depositing a second material within the at least one channel, the second material having one or more electrical properties;
depositing the first material in a predetermined arrangement to form a second layer, wherein the second layer covers at least a portion of the first layer; and,
providing electrical access to the second material to enable observation of the one or more electrical properties.

2. The method of claim 1, wherein the depositing a first material further includes using an additive manufacturing technique.

3. The method of claim 1, wherein the depositing a second material further includes using an additive manufacturing technique.

4. The method of claim 1, wherein the predetermined arrangement further includes a plurality of consecutive layers, each of which is a cross-sectional profile of the sensor design.

5. The method of claim 1, wherein the second material includes a conductive elastomer, and the one or more electrical properties includes piezoresistive properties.

6. The method of claim 1, wherein the second material includes a room temperature vulcanizing silicone suspension of electrically conductive particles.

7. The method of claim 6, wherein the electrically conductive particles include nickel-coated graphite particles.

8. The object of claim 7, wherein the material includes graphite particles in a silicone RTV suspension.

9. An object comprising a plurality of consecutive layers wherein
the plurality of consecutive layers is produced using an additive manufacturing technique;
at least one layer with a first material defining one or more channels distributed therein,
a second material deposited within the one or more channels, wherein the second material is characterized by one or more electrical properties;
a first contact electrically coupled to a first location on the second material; and,
a second contact electrically coupled to a second location on the second material.

10. The object of claim 9, wherein each of the plurality of consecutive layers is a cross-sectional profile of the object.

11. The object of claim 9, wherein the first location on the material is a first end of the material and the second location on the material is a second end of the material.

12. The object of claim 9, wherein the one or more electrical properties includes piezoresistive properties.

13. The object of claim 9, wherein the second material includes a room temperature vulcanizing silicone suspension of electrically conductive particles.

14. The object of claim 13, wherein the electrically conductive particles include nickel-coated graphite particles.

15. The object of claim 9, wherein the material includes graphite particles in a silicone RTV suspension.

16. A system for fabricating a three-dimensional object with electrical properties comprising
a build chamber;
a build platform disposed within the build chamber;
a deposition head disposed within the build chamber, configured to deposit a first material onto the build platform, and configured to deposit a second material with electric properties onto the build platform;
a memory for receiving data representing a three dimensional object;
a controller for forming a layer of material, adjacent to any last formed layer of material, accordance to the data representing the three dimensional object, operable to selectively control the deposition of the first and second material within the layer.

17. The system of claim 16 wherein the controller adjusts the relative position of the deposition head with respect to the build platform during fabrication.

18. The system of claim 16 further comprising
a reservoir capable of containing a material with electrical properties;
at least one motor assembly configured to impart a force on an actuator;
a controller configured to control the motor assembly;
a deposition nozzle in fluid contact with the interior of the reservoir;
wherein the actuator imparts a force on the material; and
wherein at least some portion of the material is expelled from the reservoir.

19. The system of claim 18 wherein the motor drives a lead screw and nut assembly.

20. The system of claim 18 wherein the motor drives a pinion of a rack and pinion system.

21. The system of claim 20 wherein the motor directly drives the pinion.

22. The system of claim 20 wherein the motor indirectly drives the pinion.

23. The system of claim 22 wherein the motor drives the pinion using a cable and pulley.

24. The system of claim 18 wherein the actuator is an auger.

25. The system of claim 18 wherein the system is attached to a 3D printer.

26. The system of claim 25 wherein the reservoir is directly mounted on the deposition head of the 3D printer.

27. The system of claim 25 wherein the reservoir is mounted on the exterior of the 3D printer.

28. The system of claim 27 wherein the deposition nozzle is mounted on the deposition head of the 3D printer.

29. The system of claim 28 wherein the deposition nozzle is connected to the reservoir using an impermeable tube.

30. The system of claim 28 wherein the reservoir is mounted on a mechanically grounded frame above the 3D printer.

31. The system of claim 30 wherein the reservoir is connected to the frame with a universal joint.

32. The system of claim 18 wherein the system is attached as a tool head on a numerically controlled or computer numerically controlled system.

33. The system of claim 18 wherein the system is attached to a drill press.

34. The system of claim 18 wherein the nozzle design reduces the force required to expel high viscosity material from the reservoir.

35. The system of claim 34 wherein the material has a viscosity higher than water.

36. The system of claim 18 wherein the environmental condition of the nozzle can be controlled by the controller.

37. The system of claim 18 wherein the nozzle design reduces the buildup of particles jamming.

38. The system of claim 36 wherein the environmental condition includes at least one of temperature or pressure.
